(19) United States
(12) Patent Application Publication
(10) Pub. No.: US 2025/0311744 A1
(43) Pub. Date: Oct. 9, 2025

(54) METHOD FOR IMPARTING ANIMAL-FAT-LIKE FLAVOR IN PROCESSED FOOD PRODUCT

(71) Applicant: FUJI OIL HOLDINGS INC., Osaka (JP)

(72) Inventors: Yurina TOBA, Ibaraki (JP); Hitomi OMORI, Ibaraki (JP)

(21) Appl. No.: 18/860,928

(22) PCT Filed: May 9, 2023
(86) PCT No.: PCT/JP2023/017424

§ 371 Date: Oct. 28, 2024

(30) Foreign Application Priority Data
May 9, 2022 (JP) 2022-077181

(51) Int. Cl. A23D 7/005; A23J 3/16; A23J 3/22; A23L 27/00; A23L 27/26; A23L 27/30

(52) U.S. Cl. CPC A23D 7/005; A23J 3/16; A23J 3/227; A23L 27/26; A23L 27/33; A23L 27/80

(57) ABSTRACT

An object of the present invention is to provide a method for imparting an animal-fat-like flavor to a processed food product containing vegetable fats and oils. The present inventors have found that the animal-fat-like flavor can be imparted by dispersing an aqueous phase with dissolved sweetener in an oil phase containing vegetable fats and oils so as to have a particle diameter of 50 to 2000 nm. This makes it possible to provide the processed food product to which the animal-fat-like flavor is imparted.

### TECHNICAL FIELD

The present invention relates to a method for imparting an animal-fat-like flavor to a processed food product containing vegetable fats and oils.

### BACKGROUND ART

In consideration of recent environmental problems and the like, development of processed food products that do not use animal fat or animal materials, typified by plant based foods (PBF), has progressed. Animal fats or animal materials bring a rich flavor such as delicious taste, richness, and rich feeling to processed food products. In a processed food product in which the animal materials are not used or an amount thereof used is small, a vegetable protein material is mainly used in many cases. However, in the processed food product containing such a vegetable protein material, flavor derived from the animal materials may be reduced, and a feeling of satisfaction with the flavor at the time of eating may be reduced. There is a demand for improvement in such a situation, and various technologies have been developed.

The following technique is disclosed for imparting delicious taste and rich feeling of animal fat. Patent Literature 1 discloses a fats and oils composition containing protein and/or starch sodium octenyl succinate and fats and oils, Patent Literature 2 discloses a solid fats and oils composition containing propylene glycol alginate, alginic acid and/or a salt thereof, a polyvalent metal salt, a gelation reaction retarder, fats and oils, and water, and Patent Literature 3 discloses meat or processed meat product containing Advantame in the meat.

### CITATION LIST

### Patent Literature

Patent Literature 1: JP-A-2021-069332
Patent Literature 2: JP-A-2015-216917
Patent Literature 3: WO 2016/009686 A

### SUMMARY OF INVENTION

### Problems to be Solved by Invention

In Patent Literature 1, as a result of replication, greasy richness is not felt, and there is still room for improvement. Although the presence or absence of rich taste is described in Patent Literature 2, there is only a study example containing livestock meat, and it is unclear whether the same rich taste imparting effect can be obtained in a food product containing the vegetable protein material. In Patent Literature 3, it is disclosed that when a predetermined amount of Advanteme is added to meat or a processed meat product, greasy sweetness is imparted. However, in the case of blending the vegetable protein material, it is necessary to examine whether the greasy sweetness is imparted. In addition, it is disclosed that, even when sugar such as granulated sugar or a sweetener is directly added to the processed meat product, sweetness more than necessary is felt, which desrupts the balance of the overall flavor of the processed food product, and that a processed meat product having a well-balanced overall flavor is obtained while imparting the greasy sweetness only by adding a special sweetener, and thus it is not realistic to add animal-fat-like flavor by directly adding the sugar or the sweetener. As described above, in a processed food product containing a vegetable protein material, a technique for imparting the animal-fat-like flavor has not been established, and improvement is required.

Therefore, an object of the present invention is to provide a method for imparting an animal-fat-like flavor to a processed food product containing vegetable fats and oils.

### Solution to Problems

The present inventors have conducted studies, and resultantly found that when an aqueous phase with dissolved sweetener is dispersed with a particle diameter of 50 to 2000 nm in an oil phase containing vegetable fats and oils, an animal-fat-like flavor can be imparted, and have completed the present invention.

That is, the present invention relates to:
(1) A method for imparting an animal-fat-like flavor to a processed food product, the method including dispersing an aqueous phase with dissolved sweetener in an oil phase containing vegetable fats and oils so as to have a particle diameter of 50 to 2000 nm;
(2) The method according to (1), in which a concentration of the sweetener in the aqueous phase is 15 to 75 mass % in terms of solid content;
(3) The method according to (1) or (2), in which the sweetener is one or more selected from the group consisting of maltose, monk fruit extract, glucose, and sucrose;
(4) The method of (3), in which the sweetener is maltose;
(5) The method according to (1) or (2), in which the sweetener brought into the processed food product by the aqueous phase is 4 to 1000 ppm in terms of solid content;
(6) The method according to (3), in which the sweetener brought into the processed food product by the aqueous phase is 4 to 1000 ppm in terms of solid content;
(7) The method according to (4), in which the sweetener brought into the processed food product by the aqueous phase is 4 to 1000 ppm in terms of solid content;
(8) A processed food product containing an oil phase containing vegetable fats and oils in which an aqueous phase with dissolved sweetener is dispersed with a particle diameter of 50 to 2000 nm in an oil phase;
(9) The processed food product according to (8), in which the sweetener is one or more selected from the group consisting of maltose, monk fruit extract, glucose, and sucrose;
(10) The processed food product according to (9), in which the sweetener is maltose;
(11) A method for producing a processed food product containing an oil phase containing vegetable fats and oils, the method comprising:
a step (A) of dispersing an aqueous phase with dissolved sweetener in the oil phase so as to have a particle diameter of 50 to 2000 nm; and
a step (B) of blending a water-in-oil emulsion composition obtained in the step (A) to prepare the processed food product;
(12) The method for producing the processed food product according to (11), in which the sweetener is one or more selected from the group consisting of maltose, monk fruit extract, glucose, and sucrose; and
(13) The method for producing the processed food product according to (12), in which the sweetener is maltose.

In other words, the present invention also relates to:
(21) A method for imparting an animal-fat-like flavor to a processed food product, the method including dispersing an aqueous phase with dissolved sugar in an oil phase containing vegetable fats and oils so as to have a particle diameter of 50 to 2000 nm;
(22) The method according to (21), in which a concentration of sugar in the aqueous phase is 30 to 75 mass % in terms of solid content;
(23) The method according to (21) or (22), in which sugar brought into the processed food product by the aqueous phase is 5 to 1000 ppm in terms of solid content;
(24) A processed food product containing an oil phase containing vegetable fats and oils in which an aqueous phase with dissolved sugar is dispersed with a particle diameter of 50 to 2000 nm in an oil phase; and
(25) A method for producing a processed food product containing an oil phase containing vegetable fats and oils, the method comprising:
a step (A) of dispersing an aqueous phase with dissolved sugar in the oil phase so as to have a particle diameter of 50 to 2000 nm; and
a step (B) of blending a water-in-oil emulsion composition obtained in the step (A) to prepare the processed food product.

### Effects of Invention

According to the present invention, it is possible to easily impart an animal-fat-like flavor to a processed food product containing vegetable fats and oils.

### DESCRIPTION OF EMBODIMENTS

Hereinafter, the present invention will be specifically described.

A flavor of animal fat according to the present invention is delicious taste of the animal fat that is felt when a food product containing livestock meat or animal fat is eaten. The delicious taste of the animal fat is a term expressing unique deliciousness, richness, and rich feeling derived from the animal fat. Sometimes the delicious taste is also expressed as “umami”. Therefore, the “flavor of animal fat” is different from sweetness felt by containing a sweetener in a processed food product.

Then, when the same umami, richness, and rich feeling as those of animal fat are imparted to vegetable fats and oils, it is expressed as “animal-fat-like flavor” in the present invention and claims. In the present invention, it is preferable to blend a vegetable protein material in the processed food product, but such a processed food product may lack umami peculiar to the animal fat. The present invention can impart the animal-fat-like flavor to the processed food product containing vegetable fats and oils, in which an aqueous phase with dissolved sweetener is dispersed with a particle diameter of 50 to 2000 nm in an oil phase.

Note that in Japanese Patent Application No. 2022-077181 which is a basic application of the present application, there is a portion where the animal-fat-like flavor in fats and oils is expressed as “sweetness”, however, it is an expression unique to Japanese, and may cause misunderstanding, and thus an expression of “animal-fat-like flavor” is unified in the present application. However, the invention is the same, and priority to Japanese Patent Application No. 2022-077181 is valid.

In the present invention, the aqueous phase with dissolved sweetener needs to be dispersed in the oil phase. Examples of the sweetener herein include glucose and fructose which are monosaccharides; maltose which is a disaccharide; sugars such as sucrose; sugar alcohols such as maltitol; and high-intensity sweeteners including sucralose, monk fruit extract, stevia, and the like, and molasses and fructose glucose liquid sugars containing these sweeteners can also be used. The sweeteners include any of those extracted from natural products and those artificially synthesized. Maltose, monk fruit extract, glucose, and sucrose are more preferable, maltose and monk fruit extract are still more preferable, and maltose is yet still more preferable. By using an appropriate sweetener, it is possible to impart the animal-fat-like flavor to the processed food product.

Note that it is desirable not to use Advanteme as the sweetener. Advanteme is one type of high-intensity sweetener, but it is known that it has a strong intensity of sweetness. Even when Advanteme is dispersed in the oil phase by a method according to the present invention, a strong sweetness may be felt in the processed food product due to the strong intensity of sweetness, and overall flavor of the processed food product may be impaired.

The oil phase referred to in the present invention includes the fats and oils and components dissolved in the fats and oils in raw materials. Specifically, the oil phase includes a part or all of fat and oil raw materials in the processed food product of the present invention.

Then, in the method according to the present invention, it is necessary that the oil phase of the processed food product contains the vegetable fats and oils. The vegetable fats and oils that can be used in the present invention are not particularly limited, and normal edible vegetable fats and oils can be used. Further, as the oil phase, animal fat such as lard, beef tallow, and fish oil can also be used in addition to the vegetable fats and oils. However, in view of the spirit of the present invention, an aspect in which the animal fat is not used is desirable. In addition to these fats and oils, a mixture of components dissolved in the fats and oils can also be referred to as the oil phase. For example, when the processed food product is a hamburg steak, the animal fat extracted from the livestock meat and a component derived from animal and dissolved in the fats and oils can be used as the oil phase in addition to the vegetable fats and oils. In addition, in the case of a processed food product which is called meatless and does not contain livestock meat or a processed food product that does not use animal raw materials (hereinafter referred to as a processed food product without animal raw materials), the vegetable fats and oils and a component that is derived from plants and dissolved in the fats and oils can be used as the oil phase. A ratio of the vegetable fats and oils contained in the oil phase is preferably 1 to 100 mass % of the fats and oils used in the raw materials. The ratio is more preferably 70 to 100 mass %, 80 to 100 mass %, 90 to 100 mass %, or 95 to 100 mass %. For example, when the processed food product is a meatless hamburg steak or a meatless hamburg steak without animal raw materials, the vegetable fats and oils contained in the oil phase is 100 mass % because the animal materials are not used. By containing an appropriate amount of vegetable fats and oils, it is possible to impart the animal-fat-like flavor to the processed food product.

In the oil phase, an oil-soluble component can be dissolved as long as effect of the present invention is not impaired, and specific examples thereof include an oil-soluble emulsifier, a pigment, and a flavor. In particular, since the present invention has a so-called water-in-oil emulsion structure in which the aqueous phase is finely dispersed in the oil phase, it is preferable to use an oil-soluble emulsifier having a function of stabilizing the emulsion structure. The oil-soluble emulsifier referred to herein is an emulsifier which has an HLB of 7 or less and is dissolved in fats and oils, and specifically, the oil-soluble emulsifier is preferably one or more selected from polyglycerin ester, sugar ester, sorbitan ester, and monoglycerin fatty acid ester. Polyglycerin ester, sugar ester, and distilled monoglyceride are more preferable, and polyglycerin ester is still more preferable. Among them, polyglycerin condensed ricinoleic acid ester is most preferable. Note that the polyglycerin condensed ricinoleic acid ester may be abbreviated as PGPR.

In the present invention, concentration of the sweetener in the aqueous phase with dissolved sweetener is preferably 15 to 75 mass % in terms of solid content. The concentration is more preferably 20 to 70 mass %, 30 to 70 mass %, 35 to 65 mass %, or 40 to 65 mass %. When the concentration of the sweetener in the aqueous phase is appropriate, it is possible to impart the animal-fat-like flavor to the processed food product.

In the present invention, the aqueous phase with dissolved sweetener needs to be dispersed in the oil phase, and the particle diameter of the aqueous phase at this time needs to be 50 to 2000 nm. This value is more preferably 55 to 1200 nm, 60 to 800 nm, 60 to 700 nm, 65 to 650 nm, and 65 to 600 nm. When the particle diameter of the aqueous phase in the oil phase is appropriate, it is possible to impart the animal-fat-like flavor to the processed food product. Note that a method for measuring the particle diameter of the aqueous phase is as follows. It is obtained by diluting 10 μL of water-in-oil emulsion composition with 2 mL of hexane and measuring with Zetasizer Nano S (manufactured by Malvern Panalytical Ltd.) (temperature: 20° C., equilibration time: 240 seconds, glass cell used).

In the present invention, an amount of the sweetener brought into the processed food product by the aqueous phase is preferably 4 to 1000 ppm. The amount is more preferably 4.5 to 900 ppm, 5 to 900 ppm, 10 to 800 ppm, 20 to 600 ppm, 30 to 500 ppm, 50 to 400 ppm, and 50 to 350 ppm. When the amount of the sweetener brought into the processed food product by the aqueous phase is appropriate, it is possible to impart the animal-fat-like flavor to the processed food product.

The processed food product according to the present invention preferably contains the vegetable protein material. In the processed food product according to the present invention, the effect of the present invention can be more preferably obtained when the vegetable protein material is blended in the processed food product preferably in an amount of 1 mass % or more on a dry weight basis. When the amount is more preferably 3 mass % or more, 5 mass % or more, 7 mass % or more, or 10 mass % or more, the effect of the present invention can be maximized.

Specific examples of the processed food product according to the present invention include hamburg steak, patty, meat ball, nugget, chicken ball, ham, salami, sausage, gyoza, shumai, meat bun, xiaolongbao, minced meat cutlet, croquette, frankfurter, corn dog, meat pie, ravioli, lasagna, meatloaf, stuffed cabbage, and paste products such as meat-stuffed green pepper and meat-stuffed lotus root. Other examples include seasonings typified by a sauce for beef bowl, sukiyaki, pork cutlet and egg dish, and chicken and egg bowl, as well as stock for ramen and soups. Further examples include processed food products such as curry, keema curry, and meat sauce. The present invention also includes processed food products such as jerky and sliced meat for grilled meat for PBF. These processed food products also include frozen products, refrigerated products, dried products, and retort products.

As the vegetable protein material used in the present invention, a material suitable for a product form of the processed food product, such as a textured vegetable protein material, a powdered vegetable protein material, or an emulsion curd, can be appropriately used.

The textured vegetable protein material that can be used as the vegetable protein material used in the present invention is obtained by blending a plant-derived protein material and texturing the mixture under high temperature and high pressure using a texturing device such as an extruder, and has a shape such as a granular shape, a fibrous shape, a flake shape, a sliced-meat shape, or a film shape. Examples of the plant-derived protein material include protein materials derived from oil seed such as soybean, pea, mung bean, chick bean, rapeseed, cotton seed, peanut, sesame, safflower, sunflower, corn, and bastard saffron, and protein materials derived from grain seed such as rice, barley, and wheat. Further, the protein material is a pulverized product, an extracted protein, a concentrated protein, a separated protein, or the like of the above-mentioned plants. Examples thereof include rice glutelin, barley prolamin, wheat prolamin, wheat gluten, whole fat soybean flour, defatted soybean flour, concentrated soybean protein, separated soybean protein, separated pea protein, and separated mung bean protein. Note that although some products are distributed after being rehydrated, it is preferable to use a dry product (water content: 10 mass % or less) in the present invention. Further, a soybean material texturized by squeezing bean curd is also suitable for the present invention. A textured soybean protein containing soybean as a main raw material is suitable for the present invention. As the textured vegetable protein material, a product having an arbitrary shape and size can be appropriately selected and used according to a desired product form. Product forms called soybean meat and soybean puff can also be used. Protein content in the textured vegetable protein material is preferably at least 30 mass % or more in the dry weight of the material. The content is more preferably 40 mass % or more, and still more preferably 50 mass %.

The powdered vegetable protein material that can be used as the vegetable protein material used in the present invention is obtained by powdering a vegetable raw material exemplified by soybean, wheat, pea, chick bean, mung bean, rice, barley, and the like, and contains 50 mass % or more of protein per solid content after defatting. Soybean is suitable for the present invention. A commercially available powdered vegetable protein material can be appropriately selected and used. Further, as the powdered vegetable protein material, in order to improve dispersibility in dough, a powdered material obtained by adding fats and oils in advance can also be used. Further, an oil-in-water emulsion that has been imparted with a function of connecting doughs, such as the emulsion curd, can also be used. Also in this case, a powdered soybean protein material containing soybean as the main raw material is suitable. Note that the emulsion curd as used herein refers to an emulsion containing a powdered vegetable protein material, water, and fats and oils and homogenized.

The processed food product according to the present invention may contain the livestock meat or the animal fat. The term “livestock meat” as used herein refers to birds and animals meat such as beef, pork, chicken, horse, lamb, deer, boar, turkey, duck, ostrich, and whale, and these can be used alone or in combination of two or more kinds thereof. Here, birds and animals may be land animals or aquatic animals, but the land animals are preferable. Further, a portion of the meat to be used is not particularly limited. A minced livestock meat can also be used. When the livestock meat is used in the processed food product, a use amount thereof is preferably 30 mass % or less in the processed food product. The amount is more preferably 20 mass % or less, 10 mass % or less, 5 mass % or less, 3 mass % or less, 1 mass % or less, or 0 mass %. The use amount of the livestock meat may be appropriately determined according to quality or concept required for the product. In view of the spirit of the present invention, an aspect in which the livestock meat is not used is desirable.

In addition, the animal fat used herein refers to fats and oils isolated or extracted from the above-described birds and animals meat. When the animal fat is used in the processed food product, a use amount thereof is preferably 30 mass % or less in the processed food product. The amount is more preferably 20 mass % or less, 15 mass % or less, 10 mass % or less, 8 mass % or less, 5 mass % or less, 4 mass % or less, 3 mass % or less, 1 mass % or less, or 0 mass %. The use amount of the animal fat may be appropriately determined according to quality or concept required for the product. For example, in the case of a meatless processed food product or a meatless processed food product without animal raw materials, the livestock meat and the animal fat are not used at all. Note that in view of the spirit of the present invention, the aspect in which the animal fat is not used is desirable.

### (Other Raw Materials)

In the processed food product according to the present invention, known materials and food additives can be used. For example, vegetable, starch, seasoning (salt, pepper, sugar, soy sauce, and the like), processed starch, dietary fiber, egg yolk, egg white, emulsifier, spice, flavor, other known additives, and the like can be appropriately used as long as the effect of the present invention are not hindered. In the case of the meatless processed food product or the processed food product without animal raw materials, a vegetable raw material is used.

Further, the present invention can also be regarded as a processed food product containing vegetable fats and oils to which the animal-fat-like flavor is imparted. Specifically, it is characterized in that the aqueous phase with dissolved sweetener is dispersed with a particle size of 50 to 2000 nm in the oil phase.

Furthermore, the present invention can also be regarded as a method for producing a processed food product containing vegetable fats and oils to which the animal-fat-like flavor is imparted. Specifically, it is characterized in that the aqueous phase with dissolved sweetener is dispersed with a particle diameter of 50 to 2000 nm in the oil phase.

A specific method of the present invention will be described.

In the present invention, the sweetener is dissolved in water to prepare the aqueous phase. Type of sweetener used here and concentration of sugar in the aqueous phase are as described above. In addition, the oil phase is prepared, and as the oil phase, all or a part of fats and oils as the raw material is used in the processed food product according to the present invention. If necessary, the oil-soluble emulsifier or the like is dissolved in the oil phase.

Next, the obtained aqueous phase is dispersed in the oil phase to prepare the water-in-oil emulsion composition. Various methods can be used for dispersion. Specifically, it is possible to use a two-liquid collision type emulsifying device called a high-pressure homogenizer, an ultrasonic emulsifier, or a wet jet mill. By using an appropriate emulsifying device, a predetermined water-in-oil emulsion composition can be obtained. Note that a general emulsification condition in the case of using the high-pressure homogenizer is treatment of 10 to 30 passes at 30 to 40 MPa. This makes it possible to set the particle diameter of the aqueous phase in the oil phase to 50 to 2000 nm.

The water-in-oil emulsion composition is mixed with other raw materials of the processed food product, and the processed food product is prepared by a predetermined method. Hereinafter, embodiments of the invention will be described in more detail with reference to Examples.

Note that when the water-in-oil emulsion composition is solid at normal temperature and is used in a paste product, the water-in-oil emulsion composition can also be compounded by being divided into small pieces with a shredder such as a Robocoupe, a chopper, or a silent cutter immediately before preparing the paste product. Shape of the small piece is not particularly limited as long as a longest side thereof is 15 mm or less. Specific examples thereof include a columnar shape, a cubic shape, a circular shape, a semicircular shape, a polyhedron such as a polygonal pyramid and a polygonal prism, and a slice shape.

### Examples

Hereinafter, the present invention will be described in more detail. It is noted that the terms “part” and “%” in the text are on a mass basis unless otherwise stated.

### <Examination 1> Preparation of Water-In-Oil Emulsion Composition

Water-in-oil emulsion compositions were prepared according to the formulation described in Tables 1-1 and 1-2. A preparation method was as follows. Raw materials classified into the aqueous phase and the oil phase were respectively mixed to prepare the aqueous phase and the oil phase. The oil phase was stirred, and the aqueous phase was gradually added thereto to prepare a substantial emulsion. The substantial emulsion was supplied to the high-pressure homogenizer (30 to 40 MPa× 10 to 30 passes) to obtain the water-in-oil emulsion composition. Each water-in-oil emulsion composition was stored in a freezer (4° C. for 12 hours) overnight. Note that the particle diameter of the aqueous phase was measured according to the following method.

### (Method for Measuring Particle Diameter of Aqueous Phase)

10 μL of the water-in-oil emulsion composition was diluted with 2 mL of hexane and measured with Zetasizer Nano S (manufactured by Malvern Panalytical Ltd.). Measurement conditions were as follows: temperature 20.0° C., equilibrium time 240 seconds, use of a glass cell, measurement angle 173°, positioning method: optimum position selection, and automatic attenuation selection. Particle diameters of aqueous phases of water-in-oil emulsion compositions 1 to 8 were 400 to 660 nm (Table 1-1 and 1-2).

TABLE 1-1

| | | | Solid content | | | | |
|---|---|---|---|---|---|---|---|
| | | | of each | Water-in-oil | Water-in-oil | Water-in-oil | Water-in-oil |
| | | | sweetner | emulsion | emulsion | emulsion | emulsion |
| (Formulation: [mass %]) | | | [mass %] | composition 1 | composition 2 | composition 3 | composition 4 |
| Oil phase | Vegetable fats and oils | | — | 99.55 | 99.7 | 99.55 | 99.7 |
| | Emulsifier | | — | 0.12 | 0.12 | 0.12 | 0.12 |
| Aqueous | Water | | — | 0.18 | 0.03 | 0.18 | 0.18 |
| phase | Sweetener | Glucose | 98 | 0.15 | — | — | — |
| | | Maltose | 75 | — | 0.15 | — | — |
| | | Sucrose | 99 | — | — | 0.15 | — |

| | | | | | |
|---|---|---|---|---|---|
| Particle diameter [nm] | — | 407.9 | 653.2 | 413.6 | 402.5 |

| | | | | |
|---|---|---|---|---|
| Solid content derived from sweetner in water-in-oil emulsion | 0.15 | 0.11 | 0.15 | 0 |
| composition [mass %] | | | | |
| Solid content concentration of sweetner in aqueous phase | 45.5 | 61.1 | 45.5 | 0 |
| [mass %] | | | | |

TABLE 1-2

| | | | Solid content | | | | |
|---|---|---|---|---|---|---|---|
| | | | of each | Water-in-oil | Water-in-oil | Water-in-oil | Water-in-oil |
| | | | sweetner | emulsion | emulsion | emulsion | emulsion |
| (Formulation: [mass %]) | | | [mass %] | composition 5 | composition 6 | composition 7 | composition 8 |
| Oil phase | Vegetable fats and oils | | — | 99.9 | 99.86 | 99.86 | 99.86 |
| | Emulsifier | | — | 0.015 | 0.015 | 0.015 | 0.015 |
| Aqueous | Water | | — | 0.09 | 0.018 | 0.018 | 0.018 |
| phase | Sweetener | Maltitol | 98 | 0.086 | — | — | — |
| | | Monk fruit extract | 97 | — | 0.005 | — | — |
| | | Stevia/Monk fruit | 97 | — | — | 0.005 | — |
| | | mixed extract | | | | | |
| | | Sucralose | 99 | — | — | — | 0.005 |

| | | | | | |
|---|---|---|---|---|---|
| Particle diameter [nm] | — | 349.5 | 407.9 | 510.0 | 392.6 |

| | | | | |
|---|---|---|---|---|
| Solid content derived from sweetner in water-in-oil emulsion | 0.084 | 0.005 | 0.005 | 0.005 |
| composition [mass %] | | | | |
| Solid content concentration of sweetner in aqueous phase | 48.9 | 21.7 | 21.7 | 21.7 |
| [mass %] | | | | |

As the vegetable fats and oils, “Unishort MJ” (manufactured by Fuji Oil Co., Ltd., derived from palm, melting point: 26° C.) was used.
As the emulsifier, “Poem PR-100” (polyglycerin condensed ricinoleic acid ester manufactured by Riken Vitamin Co., Ltd., HLB: 1) was used.
As glucose, glucose manufactured by Wako Pure Chemical Industries, Ltd. was used.
As maltose, “Malstar MS720N” (maltose syrup manufactured by Sanwa Starch Co., Ltd.) was used.
As sucrose, “granulated sugar” (manufactured by Wada Sugar Refining Co., Ltd.) was used.
As sucralose, “sucralose” (manufactured by San-Ei Gen F.F.I., Inc.) was used.
As maltitose, “Lesys” (manufactured by Mitsubishi Corporation Life Sciences Limited.) was used.
As the monk fruit extract, “Sannature M50” (manufactured by San-Ei Gen F.F.I., Inc.) was used.
As a mixed extract of stevia and monk fruit, “Sannature MSR” (manufactured by San-Ei Gen F.F.I., Inc.) was used.

### <Examination 2>Examination of Meatless Hamburg Steak

Meatless hamburg steaks were prepared according to the formulation in Tables 2-1 and 2-2. That is, an emulsion curd A was first prepared, a five times hydrated textured soybean protein material A (“Apex 650”, manufactured by Fuji Oil Co., Ltd.) and a three times hydrated textured soybean protein material B (“Apex 350”, manufactured by Fuji Oil Co., Ltd.) were added thereto and mixed for 1 minute with Kenmix (dial: MIN) (Aicoh Premium KMM770 (manufactured by AICOHSHA MFG. CO., LTD.)), a seasoning and a spice were added thereto and mixed for 1 minute, vegetables were added thereto and mixed for 30 seconds, and breadcrumbs, starch, beef tallow, or a water-in-oil emulsion composition, maltose added vegetable fats and oils, vegetable fats and oils and maltose were added thereto and mixed for 30 seconds. The mixed dough was molded into 1 piece of 50 g, and baked at 300° C. for 4.5 minutes (core temperature: 80° C., steam convection oven (manufactured by Rational Japan Co., Ltd.)). The baked meatless hamburg steak was stored in a refrigerator overnight and then stored in a freezer.

Note that in a method for preparing the emulsion curd A, 4.5 parts of water and 1 part of a textured soybean protein material (“FUJIPRO FR”, manufactured by Fuji Oil Co., Ltd.) were stirred at 1500 rpm for 1.5 minutes (Robocoupe (manufactured by FMI Corporation)), 1 part of rapeseed oil was added thereto and stirred for 4 minutes, and 1 part of dried albumen was further added thereto and stirred for 1 minute and used.

In addition, beef tallow, vegetable fats and oils, maltose added vegetable fats and oils, and water-in-oil emulsion compositions were stored in the freezer until being used, and pulverized into 8 mm cubes with the Robocoupe before being blended into the meatless hamburg steak, and then used.

The maltose contained in the processed food products of Comparative Examples 1 and 2 was blended in the same amount as the maltose content brought from the aqueous phase in Example 2. In Comparative Example 1, vegetable fats and oils and maltose were directly added to a dough, and in Comparative Example 2, maltose was directly added to melted vegetable fats and oils, and mixed, cooled, solidified, and used. In addition, the content of vegetable fats and oils in the oil phase was 48.2 mass % in Reference Example 1, and 100.0 mass % in Examples 1 to 7 and Comparative Examples 1 to 4.

TABLE 2-1

| | | Reference | | | | Comparative | Comparative |
|---|---|---|---|---|---|---|---|
| [mass %] | | Example 1 | Example 1 | Example 2 | Example 3 | Example 1 | Example 2 |
| Textured soybean | Textured soybean protein A | 2.7 | 2.7 | 2.7 | 2.7 | 2.7 | 2.7 |
| protein material A | Rehydration water | 13.7 | 13.7 | 13.7 | 13.7 | 13.7 | 13.7 |
| Textured soybean | Textured soybean protein B | 3.7 | 3.7 | 3.7 | 3.7 | 3.7 | 3.7 |
| protein material B | Rehydration water | 11 | 11 | 11 | 11 | 11 | 11 |
| Emulsion curd A | | 27.5 | 27.5 | 27.5 | 27.5 | 27.5 | 27.5 |
| Fats and oils | Beef tallow | 9.1 | — | — | — | — | — |
| | Vegetable fats and oils | — | — | — | — | 9.09 | — |
| | Maltose added vegetable fats and oils | — | — | — | — | — | 9.1 |

| | | | | | | |
|---|---|---|---|---|---|---|
| Water-in-oil emulsion composition 1 | — | 9.1 | — | — | — | — |
| Water-in-oil emulsion composition 2 | — | — | 9.1 | — | — | — |
| Water-in-oil emulsion composition 3 | — | — | — | 9.1 | — | — |
| Maltose | — | — | — | — | 0.01 | — |
| Onion | 20.1 | 20.1 | 20.1 | 20.1 | 20.1 | 20.1 |
| Starch | 1.8 | 1.8 | 1.8 | 1.8 | 1.8 | 1.8 |
| Dried breadcrumbs | 1.8 | 1.8 | 1.8 | 1.8 | 1.8 | 1.8 |
| Dried albumen | 2.7 | 2.7 | 2.7 | 2.7 | 2.7 | 2.7 |
| Seasoning, Spice | 5.9 | 5.9 | 5.9 | 5.9 | 5.9 | 5.9 |
| Total | 100 | 100 | 100 | 100 | 100 | 100 |
| Content of sweetener brought from water-in-oil emulsion | 0 | 136.5 | 100.1 | 136.5 | 0 | 0 |
| composition in processed food product [ppm] | | | | | | |
| Content of vegetable fats and oils in oil phase [masss %] | 48.2 | 100.0 | 100.0 | 100.0 | 100.0 | 100.0 |
| Flavor evaluation results | 5 | 3 | 4 | 3 | 1 | 1 |

TABLE 2-2

| | | Comparative | | | | |
|---|---|---|---|---|---|---|
| [mass %] | | Example 3 | Example 4 | Example 5 | Example 6 | Example 7 |
| Textured soybean | Textured soybean protein A | 2.7 | 2.7 | 2.7 | 2.7 | 2.7 |
| protein material A | Rehydration water | 13.7 | 13.7 | 13.7 | 13.7 | 13.7 |
| Textured soybean | Textured soybean protein B | 3.7 | 3.7 | 3.7 | 3.7 | 3.7 |
| protein material B | Rehydration water | 11 | 11 | 11 | 11 | 11 |

| | | | | | |
|---|---|---|---|---|---|
| Emulsion curd A | 27.5 | 27.5 | 27.5 | 27.5 | 27.5 |
| Water-in-oil emulsion composition 4 | 9.1 | — | — | — | — |
| Water-in-oil emulsion composition 5 | — | 9.1 | — | — | — |
| Water-in-oil emulsion composition 6 | — | — | 9.1 | — | — |
| Water-in-oil emulsion composition 7 | — | — | — | 9.1 | — |
| Water-in-oil emulsion composition 8 | — | — | — | — | 9.1 |
| Onion | 20.1 | 20.1 | 20.1 | 20.1 | 20.1 |
| Starch | 1.8 | 1.8 | 1.8 | 1.8 | 1.8 |
| Dried breadcrumbs | 1.8 | 1.8 | 1.8 | 1.8 | 1.8 |
| Dried albumen | 2.7 | 2.7 | 2.7 | 2.7 | 2.7 |
| Seasoning, Spice | 5.9 | 5.9 | 5.9 | 5.9 | 5.9 |
| Total | 100 | 100 | 100 | 100 | 100 |
| Content of sweetener brought from water-in-oil emulsion | 0 | 76.7 | 4.4 | 4.4 | 4.4 |
| composition in processed food product [ppm] | | | | | |
| Content of vegetable fats and oils in oil phase [masss %] | 100.0 | 100.0 | 100.0 | 100.0 | 100.0 |
| Evaluation results of flavor | 0 | 3 | 3 | 4 | 3.5 |

### (Method for Evaluating Flavor)

The frozen hamburg steak was warmed in a microwave oven (500 watts, 2 min), thawed, heated, caten, and evaluated according to the following criteria. Sensory evaluation was performed by six skilled panelists, and a rating of more than 2 points (average score) was determined by consultation to have a beef tallow-like flavor.

Evaluation results are shown in Tables 2-1 and 2-2.

### (Evaluation Criteria)

The flavor (umami, richness, rich feeling, and the like) of beef tallow felt in the hamburg steak of Reference Example 1 containing beef tallow was rated as 5 points.
0 point: Beef tallow-like flavor was not felt at all as compared with Reference Example 1.
1 point: Flavor similar to the flavor of beef tallow felt in Reference Example 1 was felt, and the intensity was 30% of that of Reference Example.
2 points: Flavor similar to the flavor of beef tallow felt in Reference Example 1 was felt, and the intensity was 60% of that of Reference Example.
3 points: Flavor similar to the flavor of beef tallow felt in Reference Example 1 was felt, and the intensity was 80% of that of Reference Example.
4 points: Flavor similar to the flavor of beef tallow felt in Reference Example 1 was felt, and the intensity was 90% of that of Reference Example.
5 points: Flavor similar to the flavor of beef tallow felt in Reference Example 1 was felt, and the intensity was equivalent to that of Reference Example.

In Examples 1 to 7 containing the water-in-oil emulsion compositions 1 to 3 and 5 to 8, a flavor similar to the flavor of beef tallow felt in Reference Example 1 was felt, and the intensity was 80% to 90% of that of Reference Example. Regarding the type of sweetener, there was a tendency that the effect was strong in each sugar and the monk fruit extract. Regarding the type of sugar, maltose was most effective. On the other hand, when the same amount of maltose as contained in the hamburg steak of Example 2 was directly blended in the dough (Comparative Example 1) and when maltose was directly blended in the vegetable fats and oils (Comparative Example 2), the intensity was only 30% of that of Reference Example 1 as compared with the flavor of beef tallow felt in Reference Example 1. In addition, when no sugar was added (Comparative Example 3), no beef tallow-like flavor was felt as compared with the flavor of beef tallow felt in Reference Example 1.

### <Examination 3> Preparation of Water-In-Oil Emulsion Composition

The water-in-oil emulsion compositions were prepared according to the formulation described in Table 3. The preparation method followed Examination 1. The raw materials used for the water-in-oil emulsion compositions were the same as in Examination 1. Particle diameters of aqueous phases of water-in-oil emulsion compositions 9 to 15 were 84 to 770 nm or less (Table 3).

TABLE 3

| | | Solid | Water- | Water- | Water- | Water- | Water- | Water- | Water- |
|---|---|---|---|---|---|---|---|---|---|
| | | content | in-oil | in-oil | in-oil | in-oil | in-oil | in-oil | in-oil |
| | | of each | emulsion | emulsion | emulsion | emulsion | emulsion | emulsion | emulsion |
| | | sweetner | composi- | composi- | composi- | composi- | composi- | composi- | composi- |
| (Formulation: [mass %]) | | [mass %] | tion 9 | tion 10 | tion 11 | tion 12 | tion 13 | tion 14 | tion 15 |
| Oil | Vegetable fats and oils | — | 99.874 | 99.868 | 99.82 | 99.7 | 99 | 98 | 99.7 |
| phase | Emulsifier | — | 0.12 | 0.12 | 0.12 | 0.12 | 0.4 | 0.8 | 0.12 |
| Aqueous | Water | — | 0.001 | 0.002 | 0.01 | 0.03 | 0.1 | 0.2 | 0.03 |
| phase | Maltose | 75 | 0.005 | 0.01 | 0.05 | 0.15 | 0.5 | 1 | 0.15 |
| | Particle diameter [nm] | — | 531.4 | 479.4 | 450.5 | 563.2 | 568.5 | 761.3 | 84.9 |

| | | | | | | | |
|---|---|---|---|---|---|---|---|
| Solid content derived from sweetner | 0.004 | 0.008 | 0.038 | 0.11 | 0.375 | 0.750 | 0.11 |
| in water-in-oil emulsion composition | | | | | | | |
| [mass %] | | | | | | | |
| Solid content concentration of sweetner | 66.7 | 66.7 | 63.3 | 61.1 | 62.5 | 62.5 | 61.1 |
| in aqueous phase [mass %] | | | | | | | |

### <Examination 4>Examination of Meatless Hamburg Steak

According to the formulation in Table 4, meatless hamburg steaks were prepared by the same method as the preparation method in Examination 2. A method for evaluating the flavor was carried out in the same manner as in Examination 2, and the flavor was evaluated in comparison with Reference Example 2 (seven panelists). Results are shown in Table 4. Note that the content of vegetable fats and oils in the oil phase was 48.2 mass % in Reference Example 2, and 100.0 mass % in Examples 8 to 13 and Comparative Example 4.

TABLE 4

| | | Reference | Comparative | Exam- | Exam- | Exam- | Exam- | Exam- | Exam- |
|---|---|---|---|---|---|---|---|---|---|
| [mass %] | | Example 2 | Example 4 | ple 8 | ple 9 | ple 10 | ple 11 | ple 12 | ple 13 |
| Textured soybean | Textured soybean protein A | 2.7 | 2.7 | 2.7 | 2.7 | 2.7 | 2.7 | 2.7 | 2.7 |
| protein material A | Rehydration water | 13.7 | 13.7 | 13.7 | 13.7 | 13.7 | 13.7 | 13.7 | 13.7 |
| Textured soybean | Textured soybean protein B | 3.7 | 3.7 | 3.7 | 3.7 | 3.7 | 3.7 | 3.7 | 3.7 |
| protein material B | Rehydration water | 11 | 11 | 11 | 11 | 11 | 11 | 11 | 11 |

| | | | | | | | | |
|---|---|---|---|---|---|---|---|---|
| Emulsion curd A | 27.5 | 27.5 | 27.5 | 27.5 | 27.5 | 27.5 | 27.5 | 27.5 |
| Beef tallow | 9.1 | — | — | — | — | — | — | — |
| Water-in-oil emulsion composition 9 | — | 9.1 | — | — | — | — | — | — |
| Water-in-oil emulsion composition 10 | — | — | 9.1 | — | — | — | — | — |
| Water-in-oil emulsion composition 11 | — | — | — | 9.1 | — | — | — | — |
| Water-in-oil emulsion composition 12 | — | — | — | — | 9.1 | — | — | — |
| Water-in-oil emulsion composition 13 | — | — | — | — | — | 9.1 | — | — |
| Water-in-oil emulsion composition 14 | — | — | — | — | — | — | 9.1 | — |
| Water-in-oil emulsion composition 15 | — | — | — | — | — | — | — | 9.1 |
| Onion | 20.1 | 20.1 | 20.1 | 20.1 | 20.1 | 20.1 | 20.1 | 20.1 |
| Starch | 1.8 | 1.8 | 1.8 | 1.8 | 1.8 | 1.8 | 1.8 | 1.8 |
| Dried breadcrumbs | 1.8 | 1.8 | 1.8 | 1.8 | 1.8 | 1.8 | 1.8 | 1.8 |
| Dried albumen | 2.7 | 2.7 | 2.7 | 2.7 | 2.7 | 2.7 | 2.7 | 2.7 |
| Seasoning, Spice | 5.9 | 5.9 | 5.9 | 5.9 | 5.9 | 5.9 | 5.9 | 5.9 |
| Total | 100 | 100 | 100 | 100 | 100 | 100 | 100 | 100 |
| Content of sweetener brought from water-in-oil emulsion | 0 | 3.6 | 7.3 | 34.6 | 100.1 | 341.3 | 682.5 | 100.1 |
| composition in processed food product [ppm] | | | | | | | | |
| Content of vegetable fats and oils in oil phase [masss %] | 48.2 | 100.0 | 100.0 | 100.0 | 100.0 | 100.0 | 100.0 | 100.0 |
| Flavor evaluation results | 5 | 1 | 2.2 | 3.2 | 4 | 3.2 | 2.5 | 4.5 |

In contrast to Reference Example 2, in Comparative Example 4 in which the amount of maltose brought from the water-in-oil emulsion composition into the hamburg steak was 3.6 ppm, the beef tallow-like flavor was felt, but the intensity was only 30% of that of Reference Example 2. In Examples 8 to 13 in which the amount of maltose brought into the hamburg steak from the water-in-oil emulsion composition was 7.3 to 682.5 ppm, the beef tallow-like flavor was felt, and the intensity was 70% to 90% of that of Reference Example. In particular, in Example 10, the beef tallow-like flavor was strongly felt. Even when the particle diameter of the water-in-oil emulsion composition was different, the beef tallow-like flavor was sufficiently felt (Example 13).

<Examination 5>Examination of Hamburg Steak without Animal Raw Materials

According to the formulation in Table 5, hamburger steaks without animal raw materials containing no animal raw materials at all was prepared. That is, an emulsion curd B was prepared in advance, the five times hydrated textured soybean protein material A and the three times hydrated textured soybean protein material B were added thereto and mixed for 1 minute with Kenmix at 150 rpm, a seasoning, a spice, a bamboo fiber (“BAF 90″ manufactured by Rettenmaier), and a citrus fiber (“Helvacell AQ Plus CF-D” manufactured by DSP Gokyo Food & Chemical Co., Ltd.) were added thereto and mixed for 1 minute, vegetables were added thereto and mixed for 30 seconds, and breadcrumbs, starch, beef tallow, or a water-in-oil emulsion composition 12 was added thereto and mixed for 1 minute. The mixed dough was molded into 1 piece of 70 g, and baked at 300° C. for 6 minutes (core temperature: 80° C., convection oven (manufactured by Rational Japan Co., Ltd.)). The baked meatless hamburg steak was stored in the refrigerator overnight and then stored in the freezer. Note that in a method for preparing the emulsion curd B, 3.2 parts of rapeseed oil and 1 part of methyl cellulose (“MCE-100TS”, manufactured by Shin-Etsu Chemical Co., Ltd.) were stirred at 100 rpm for 1.5 minutes with the Robocoupe, and 13 parts of ice water was added thereto and was mixed and stirred at 1000 rpm for 5 minutes. Note that the beef tallow and the water-in-oil emulsion composition 12 were stored in the freezer until used, and pulverized into 8 mm cubes with the Robocoupe before being blended into the hamburg steak, and then used. Note that the content of vegetable fats and oils in the oil phase was 66.0 mass % in Reference Example 3 and 100.0 mass % in Example 14.

The method for evaluating the flavor was the same method as in Examination 2, and the flavor was evaluated in comparison with Reference Example 3 (seven panelists). Results are shown in Table 5.

TABLE 5

| | | Reference | |
|---|---|---|---|
| | | Example 3 | Example 14 |
| Emulsion curd B | | 31.4 | 31.4 |
| Textured soybean | Textured soybean protein A | 2 | 2 |
| protein material A | Rehydration water | 10 | 10 |
| Textured soybean | Textured soybean protein B | 6.3 | 6.3 |
| protein material B | Rehydration water | 19 | 19 |

| | | |
|---|---|---|
| Beef tallow | 9.6 | — |
| Water-in-oil emulsion composition 12 | — | 9.6 |
| Bamboo fiber | 1.9 | 1.9 |
| Citrus fiber | 1.9 | 1.9 |
| Starch | 1.9 | 1.9 |
| Onion | 9.6 | 9.6 |
| Seasoning, Spice | 6.4 | 6.4 |
| Total | 100 | 100 |
| Content of sweetener brought from water-in-oil emulsion | 0 | 105.6 |
| composition in processed food product [ppm] | | |
| Content of vegetable fats and oils in oil phase [masss %] | 66.0 | 100.0 |
| Flavor evaluation results | 5 | 4 |

In Reference Example 3 in which the beef tallow was blended in a hamburg steak not containing animal materials, the flavor of beef tallow was felt. In contrast, in a hamburg steak containing the water-in-oil emulsion composition 12, the beef tallow-like flavor was felt, and the intensity was 90% of that of Reference Example 3.

### <Examination 6>Examination of Chicken Dumpling

According to the formulation in Table 6, chicken dumpling containing soybean protein material was prepared. That is, the emulsion curd A was prepared in advance, minced chicken breast (q 4 mm) was added thereto and mixed for 1 minute with Kenmix (dial: MIN). A three times hydrated textured soybean protein material C (“New Fujinic 52S” manufactured by Fuji Oil Co., Ltd.), seasoning, spice, and common salt were added thereto and mixed for 1 minute, minced onion was added thereto and mixed for 30 seconds, and breadcrumbs, starch, beef tallow, or the water-in-oil emulsion composition 12 was added thereto and mixed for 1 minute. The mixed dough was molded into 1 piece of 15 g, and steamed at 90° C. for 12 minutes (steam convection oven (manufactured by Rational Japan Co., Ltd.)). The steamed chicken dumpling was allowed to cool and then stored in the freezer.

Note that the method for preparing the emulsion curd A was the same as in Examination 2. Note that the beef tallow and the water-in-oil emulsion composition 12 were stored in the freezer until used, and pulverized into 8 mm cubes with the Robocoupe before being blended into the chicken dumpling, and then used. Note that the content of vegetable fats and oils in the oil phase was 45.8 mass % in Reference Example 4 and 100.0 mass % in Example 15.

The method for evaluating the flavor was the same method as in Examination 2, and the flavor was evaluated in comparison with Reference Example 4 (five panelists). Results are shown in Table 6.

TABLE 6

| | | Reference | |
|---|---|---|---|
| [mass %] | | Example 4 | Example 15 |
| Chicken breast | | 35.5 | 35.5 |
| Onion | | 15 | 15 |
| Textured soybean | Textured soybean protein C | 5 | 5 |
| protein material C | Rehydration water | 15 | 15 |

| | | |
|---|---|---|
| Emulsion curd A | 13 | 13 |
| Beef tallow | 10 | - |
| Water-in-oil emulsion composition 12 | - | 10 |
| Breadcrumbs | 3 | 3 |
| Starch | 2 | 2 |
| Common salt | 0.7 | 0.7 |
| Seasoning, Spice | 0.8 | 0.8 |
| Total | 100 | 100 |
| Content of sweetener brought from water-in-oil emulsion | 0 | 110 |
| composition in processed food product [ppm] | | |
| Content of vegetable fats and oils in oil phase [masss %] | 45.8 | 100.0 |
| Flavor evaluation results | 5 | 4 |

In the chicken dumpling containing the textured soybean protein material, the flavor of beef tallow was felt in Reference Example 4 containing beef tallow. In contrast, in Example 15 in which the water-in-oil emulsion composition 12 was blended, the beef tallow-like flavor was felt, and the intensity was 90% of that of Reference Example 4.

### <Examination 7>Examination of Beef Bowl Style

A beef bowl style was prepared according to the formulation in Table 7. Seasonings, sliced onion, and a twice hydrated textured soybean protein material D (“Vegeplus 2900” manufactured by Fuji Oil Co., Ltd.) were added to a pot, and heated to a yield of 90% with a cooking stove. To this, the beef tallow or the water-in-oil emulsion composition 12 was added, melted in an oven (90° C.× 30 minutes), and then stored in the refrigerator overnight. 50 g of the beef bowl style stored in the refrigerator was placed in a retort pack and retort sterilized at 121° C. for 30 minutes. Note that the content of vegetable fats and oils in the oil phase was 0 mass % in Reference Example 5, and 100.0 mass % in Example 16.

The method for evaluating the flavor was the same method as in Examination 2, and the flavor was evaluated in comparison with Reference Example 5 (five panelists). Results are shown in Table 7.

TABLE 7

| | | Reference | |
|---|---|---|---|
| [mass %] | | Example 5 | Example 16 |
| Onion | | 12.5 | 12.5 |
| Textured soybean | Textured soybean protein D | 4.2 | 4.2 |
| protein material D | Rehydration water | 8.3 | 8.3 |
| Beef tallow | | 12.5 | — |
| Water-in-oil emulsion composition 12 | | — | 12.5 |
| Seasonings | Soy sauce | 9.4 | 9.4 |
| | Sweet cooking rice wine | 9.4 | 9.4 |
| | Sake | 6.3 | 6.3 |
| | Sugar | 3.1 | 3.1 |
| | Seasoning | 1.3 | 1.3 |
| | Grated ginger | 0.1 | 0.1 |
| | Common salt | 0.1 | 0.1 |
| | Water | 32.8 | 32.8 |

| | | |
|---|---|---|
| Total | 100 | 100 |
| Content of sweetener brought from water-in-oil | 0 | 137.5 |
| emulsion composition in processed food product [ppm] | | |
| Content of vegetable fats and oils in oil phase [masss %] | 0 | 100.0 |
| Flavor evaluation results | 5 | 4 |

In the beef bowl style containing the textured soybean protein material, the flavor of beef tallow was felt in Reference Example 5 containing beef tallow. In contrast, in Example 16 containing the water-in-oil emulsion composition 2, the beef tallow-like flavor was felt, and the intensity was 90% of that of Reference Example 5.

### <Examination 8>Examination of Keema Curry

According to the formulation in Table 8, keema curry containing soybean protein material was prepared. That is, minced garlic was sauteed in a frying pan, and vegetables, a one and half times hydrated textured soybean protein material E (“Vegetex RET” manufactured by Fuji Oil Co., Ltd.), spice, curry powder, and seasonings were added in this order, and then sauteed over medium heat for 8 minutes. Water was added thereto and heated to a yield of 70%. The beef tallow or a water-in-oil emulsion composition 16 was added thereto, stirred and mixed so as to be uniform, and then stored in the refrigerator overnight. 30 g of the keema curry stored in the refrigerator was placed in a retort pack and retort sterilized at 121° C. for 30 minutes. Note that the water-in-oil emulsion composition 16 was prepared in the same manner as in Examination 1, formulated in the same manner as in a water-in-oil emulsion composition 8, and prepared by changing to only the vegetable fats and oils to “Parkid P” (manufactured by Fuji Oil Co., Ltd., derived from palm, melting point: 39° C.). Note that the content of vegetable fats and oils in the oil phase was 0 mass % in Reference Example 6 and 100.0 mass % in Example 17.

The method for evaluating the flavor was the same method as in Examination 2, and the flavor was evaluated in comparison with Reference Example 6 (five panelists). Results are shown in Table 8.

TABLE 8

| | | Reference | |
|---|---|---|---|
| [mass %] | | Example 6 | Example 17 |
| Textured soybean | Textured soybean protein E | 6.4 | 6.4 |
| protein material E | Rehydration water | 9.6 | 9.6 |

| | | |
|---|---|---|
| Beef tallow | 6 | — |
| Water-in-oil emulsion composition 16 | — | 6 |
| Onion | 20 | 20 |
| Carrot | 6 | 6 |
| Ginger | 2 | 2 |
| Garlic | 2 | 2 |
| Curry powder | 1.5 | 1.5 |
| Spice | 0.6 | 0.6 |
| Seasoning | 20.4 | 20.4 |
| Water | 25.5 | 25.5 |
| Total | 100 | 100 |
| Content of sweetener brought from water-in-oil emulsion | 0 | 66.0 |
| composition in processed food product [ppm] | | |
| Content of vegetable fats and oils in oil phase [masss %] | 0 | 100.0 |
| Flavor evaluation results | 5 | 4 |

In the keema curry containing the textured soybean protein material, the flavor of beef tallow was felt in Reference Example 6 containing beef tallow. In contrast, in Example 17 containing the water-in-oil emulsion composition 16, the beef tallow-like flavor was felt, and the intensity was 90% of that of Reference Example 6.

1. A method for imparting an animal-fat-like flavor to a processed food product, the method comprising dispersing an aqueous phase with dissolved sweetener in an oil phase containing vegetable fats and oils so as to have a particle diameter of 50 to 2000 nm.

2. The method according to claim 1, wherein a concentration of the sweetener in the aqueous phase is 15 to 75 mass % in terms of solid content.

3. The method according to claim 1, wherein the sweetener is one or more selected from the group consisting of maltose, monk fruit extract, glucose, and sucrose.

4. The method of claim 3, wherein the sweetener is maltose.

5. The method according to claim 1, wherein the sweetener brought into the processed food product by the aqueous phase is 4 to 1000 ppm in terms of solid content.

6. The method according to claim 3, wherein the sweetener brought into the processed food product by the aqueous phase is 4 to 1000 ppm in terms of solid content.

7. The method according to claim 4, wherein the sweetener brought into the processed food product by the aqueous phase is 4 to 1000 ppm in terms of solid content.

8. A processed food product comprising an oil phase containing vegetable fats and oils in which an aqueous phase with dissolved sweetener is dispersed with a particle diameter of 50 to 2000 nm in an oil phase.

9. The processed food product according to claim 8, wherein the sweetener is one or more selected from the group consisting of maltose, monk fruit extract, glucose, and sucrose.

10. The processed food product of claim 9, wherein the sweetener is maltose.

11. A method for producing a processed food product containing an oil phase containing vegetable fats and oils, the method comprising:
a step (A) of dispersing an aqueous phase with dissolved sweetener in the oil phase so as to have a particle diameter of 50 to 2000 nm; and
a step (B) of blending a water-in-oil emulsion composition obtained in the step (A) to prepare the processed food product.

12. The method for producing the processed food product according to claim 11, wherein the sweetener is one or more selected from the group consisting of maltose, monk fruit extract, glucose, and sucrose.

13. The method for producing the processed food product according to claim 12, wherein the sweetener is maltose.
